(19) United States
(12) Patent Application Publication
(10) Pub. No.: US 2010/0039879 A1
(43) Pub. Date: Feb. 18, 2010

(54) CEMENTING DEVICE AND METHOD

(75) Inventor: Jean Buytaert, Mineral Wells, TX (US)

Correspondence Address: Streets & Steele-Frank's International., 13100 Wortham Center Drive, Suite 245, Houston, TX, 77065, US

(73) Assignee: FRANK'S INTERNATIONAL, INC., Houston, TX (US)

(21) Appl. No.: 12/542,494

(22) Filed: Aug. 17, 2009

Related U.S. Application Data
(60) Provisional application No. 61/089,461, filed on Aug. 15, 2008.

(51) Int. Cl. B28C 7/16; B28C 7/00

(52) U.S. Cl. 366/6; 366/42

(57) ABSTRACT

A method for cementing a casing string in a borehole includes the steps of moveably coupling an outer sleeve on a casing segment; making up the casing segment with the outer sleeve into a casing string; running the casing string in a borehole; displacing a cement slurry into an annulus exterior to the casing string; and moving the outer sleeve relative to the casing string to agitate the cement slurry. A transfer device is used to rotate the outer sleeve against the cement slurry. Multiple outer sleeves may be received on the casing string at spaced intervals. In one embodiment, the transfer device may include a mechanical clutch through which the outer sleeves may be rotated. The mechanical clutch may be driven using an inner cementing string that provides a supply of cement slurry to the annulus.

### STATEMENT OF RELATED APPLICATIONS

This application claims the benefit of U.S. Provisional Patent Application No. 61/089,461 filed on Aug. 15, 2008.

### FIELD OF THE INVENTION

This application relates to cementing of a casing string in an earthen borehole, and more specifically to methods and devices for improving cement distribution between a casing string and a borehole.

### BACKGROUND

It is conventional practice to cement a casing string in a borehole to prevent collapse and stabilize the borehole. A casing string is positioned within the borehole, e.g., using casing centralizers coupled at spaced intervals along the casing string, to form an annulus between the casing string and the borehole. Cement slurry can be displaced through the bore of the casing string using cementing plugs allowing displacement into the annulus. Alternately, an inner cementing string may be run through the bore of the casing string and stung into a float device, e.g., at the end of the casing string. The float device may be a float shoe or a float collar. Cement slurry may be displaced through the inner cementing string, through the float device and into the annulus.

Borehole curvature and other borehole irregularities may impair an even distribution of cement slurry within the annulus and cause channeling of cement slurry past pockets of drilling fluid or debris. Channeling may compromise the integrity of the cement liner that protects the casing string.

The quality of a cement liner may benefit from agitation of the cement slurry within the annulus as the cement slurry is displaced along the annulus. Agitation induces turbulent flow, promotes cement bonding to the wall of the borehole and reduces channeling. Reciprocation and/or rotation of the casing string using rig equipment as cement slurry is in the annulus are conventional methods of agitating the cement slurry.

In substantially vertical boreholes, casing strings hang primarily in tension, and the casing string is more easily moved within the borehole to agitate a cement slurry. In horizontal or highly deviated boreholes, reciprocating or rotating the casing string may be less desirable because the weight of the casing string and contents bears on the floor, or downwardly disposed side, of the borehole, which reacts to support the casing string. Movement of the casing string, whether by rotation or reciprocation, is resisted by friction between the casing string and the borehole causes wear and unwanted stress on the casing string, centralizers and rig equipment.

What is needed is a system, a method and an apparatus to agitate an annular flow of cement slurry while protecting the casing string, centralizers and rig equipment from wear and/or stress caused by rotation or reciprocating of the casing string within the borehole.

### SUMMARY

Embodiments of the invention disclosed herein satisfy one or more of the above-stated needs. One embodiment of a system and apparatus comprises one or more outer sleeve movably received on a casing string and a transfer device(s) to move the outer sleeve relative to the casing string. The transfer device may rotate the outer sleeve or move the outer sleeve longitudinally relative to the casing string, or both, to agitate an annular flow of cement slurry intermediate the outer sleeve and a borehole. In some embodiments, one or more structures may be coupled to or formed on an exterior surface of the outer sleeve to enhance agitation. The structures may comprise, for example, a protuberance, such as a fin, groove, blade, ridge, or bump, or the structures may comprise a cavity, a dimple, trough or other structure that, when the exterior surface is moved against a flow of cement slurry, enhances agitation. “Casing,” “casing string” or “casing segment,” as those terms are used herein, shall refer to any tubular that may be cemented in a borehole, e.g., to stabilize a part or section of the borehole.

In one embodiment, an outer sleeve and/or the structures thereon are protected from unwanted engagement with the borehole by a centralizer (or centralizers) coupled to the casing string adjacent to the outer sleeve. For example, in one embodiment, an outer sleeve is protected by straddling the outer sleeve with a pair of centralizers to provide stand-off between the casing string and the borehole. It should be understood that the outer sleeve is more exposed to engagement with the borehole in curved or irregular sections of the borehole.

In one embodiment, the longitudinal movement of the outer sleeve along the casing string may be limited by disposing a stop collar or stop device above or in the uphole direction, relative to the outer sleeve and/or a stop collar or stop device below, or in the downhole direction, relative to the outer sleeve. It should be understood that, in embodiments that provide for reciprocation of the outer sleeve on the casing string, these stop collars or stop devices can be separated a predetermined distance to accommodate reciprocal movement of the outer sleeve. In one embodiment, the centralizers described above may be used for serving this purpose.

In another embodiment, the frictional resistance to rotation of the outer sleeve may be reduced by treating or conditioning the bore of the outer sleeve and/or the exterior of the portion of the casing string on which the outer sleeve is to be disposed. In one embodiment, one or more bearings, e.g. one or more sleeve bearing, may be disposed intermediate the bore of the outer sleeve and the casing string.

In embodiments of the system, method and apparatus, a transfer device engages and rotates and/or reciprocates the outer sleeve on a portion of the casing string. In one embodiment, the transfer device comprises a portable power source, such as a battery, coupled to an electric motor that is mechanically coupled to the outer sleeve through one or more gears. In another embodiment, an inner cementing string is run into the bore of the casing string to position and operatively couple a transfer device with the outer sleeve. For example, in one embodiment the transfer device comprises an inner gear positionable within a casing string to mechanically couple the inner cementing string to the outer sleeve. The inner gear on the inner string directly or indirectly engages a sleeve gear through a sealed aperture in the wall of the casing string. In another embodiment, the transfer device comprises one or more magnets on the inner cementing string that are positionable within the outer sleeve to magnetically couple the inner cementing string to the outer sleeve. In these latter two embodiments, the inner cementing string serves the dual purposes of supplying a flow of cement slurry to the annulus and then providing power to move the outer sleeve. For example, an inner cementing string of the kind that can facilitate certain embodiments of method and apparatus disclosed herein is available from Davis-Lynch, Inc.

An embodiment of a method to cement a casing string in a borehole includes the steps of: movably receiving one or more outer sleeves on a casing string; running the casing string in a borehole to form an annulus between the outer sleeves and the borehole; displacing a cement slurry into the annulus; and moving the outer sleeves relative to the casing string. Another embodiment of the method to cement a casing string in a borehole comprises the steps of: movably receiving one or more outer sleeves on a casing string; coupling a float device having a tag-in receptacle to the casing string; running the casing string in a borehole to form an annulus between the outer sleeves and the borehole; coupling a portion of a torque transfer device to an inner cementing string; running the inner cementing string into the bore of the casing string to sealably engage the tag-in receptacle in the float device and to position the portion of the torque transfer device within the outer sleeves; movably coupling the outer sleeves to the inner cementing string through the torque transfer device; displacing a flow of cement slurry through the inner cementing string and into the annulus; and moving the inner cementing string to move the outer sleeves relative to the casing string. After the cement slurry is displaced to the targeted interval of the annulus or agitation is no longer needed, the transfer device may be disengaged from the outer sleeves and the inner cementing string may be disengaged from the float device and recovered from the bore of the casing string. It should be understood that the inner cementing string, when sealably received within the tag-in receptacle in the float device may function in a manner similar to a swivel used on a rig for delivering a flow of fluid into the bore of a drill string. The tag-in receptacle in the float device facilitates the isolation of the flow of cement slurry delivered through the bore of the inner cementing string from the annulus intermediate the casing string and the inner cementing string so that flow can be provided to the borehole adjacent to the float device. It should be understood that this type of float device may include a rotatable tag-in receptacle to rotate with a “stinger,” or tagged-in portion, of the inner cementing string. Alternately, the inner cementing string may include a stinger that is rotatably and sealably coupled to the end of the inner cementing string so that the stinger may remain stationary and coupled to the receptacle upon rotation of the inner cementing string. In another embodiment, the stinger may be adapted to rotate within the receptacle while maintaining a seal. This latter embodiment may comprise a receptacle and/or stinger of a lubricious material.

In another embodiment, the transfer device comprises an inner gear on the inner cementing string coupled to mechanically transmit torque to an outer gear on the outer sleeve.

In one embodiment, the transfer device comprises an inner magnet coupled to the inner cementing string and an outer magnet coupled to the outer sleeve. The inner and outer magnets magnetically interact to enable the transfer of torque (for rotation) and/or a translating force (for reciprocation), or both, from the inner cementing string to the outer sleeve. It should be understood that this embodiment of the transfer device provides magnetic interaction between the inner cementing string and the outer sleeve to provide for the transfer of torque from the inner cementing string to the outer sleeve (to rotate the outer sleeve) without compromising the integrity of the casing string.

In an alternate embodiment, the transfer device comprises an inner magnet coupled to the inner cementing string and an outer magnetic body coupled to the outer sleeve. Alternately, the transfer device comprises an outer magnet coupled to the outer sleeve and an inner magnetic body coupled to the inner cementing string. In these embodiments, the magnetic attraction between the inner magnet coupled to the inner cementing string and the outer magnetic body coupled to the outer sleeve or, alternately, the magnetic attraction between the outer magnet coupled to the outer sleeve and the inner magnetic body coupled to the inner cementing string, provides a magnetic interaction between the inner cementing string and the outer sleeve to provide for the transfer of torque from the inner cementing string to the outer sleeve. It should be understood that a magnetic body, as that term is used herein, is a body comprising a material that is subjected to a force when the body is placed within a magnetic field, e.g. when positioned proximal a magnet. While these embodiments could be used to provide minimal torque transfer, the size of the magnet and/or magnetic body may present limitations.

It should be understood that, in some embodiments, the outer sleeve may be adapted to move the flow of cement slurry through the annulus as it agitates the flow. For example, as will be described in greater detail below, the outer sleeve may comprise one or more spiral fins or curved blades that may be rotated to propel the cement slurry in the uphole direction. These embodiments may further improve both the quality of the cement liner and the bond of the cement liner to the borehole by reducing the equivalent circulating density (ECD) of the cement slurry. It should be understood that the flow assistance provided by movement of the outer sleeves reduces the cumulative resistance of the borehole to annular cement flow. The ECD is the effective density exerted by a circulating fluid, such as cement slurry, against geologic formations penetrated by the borehole that takes into account the pressure drop in the annulus uphole relative to the point being considered.

The foregoing and other features and embodiments of the invention will be best understood with reference to the following detailed description of specific embodiments, when read in conjunction with the accompanying drawings, wherein:

### BRIEF DESCRIPTION OF THE DRAWINGS

The foregoing and other features and aspects will be best understood with reference to the following detailed description of embodiments of the invention, when read in conjunction with the accompanying drawings, wherein:

FIG. 1 is an elevation view of an extended reach borehole having a substantial horizontal portion and a casing string disposed therein. A plurality of outer sleeves are movably received on the casing string, each straddled by a pair of centralizers, to agitate a cement slurry displaced between the outer sleeves and the borehole.

FIG. 2 is an elevation view of an embodiment of an apparatus coupled to a casing string and disposed within a borehole.

FIG. 3 is an elevation view of an alternate embodiment of an apparatus having an outer sleeve movably coupled to a casing string and driven by a gear on an inner cementing string.

FIG. 4 is an elevation view of another alternate embodiment of an apparatus having an outer sleeve movably coupled to a casing string and driven by a battery and a motor.

FIG. 5 is an elevation view of an embodiment of an apparatus having an outer sleeve movably coupled to a casing string and driven by an inner cementing string and a magnetic clutch. The magnetic clutch of FIG. 5 comprises a plurality of outer magnets on the outer sleeve.

FIG. 5A is an elevation view of an embodiment of a transfer device comprising an inner cementing string and a plurality of inner magnets to cooperate with the plurality of outer magnets on the outer sleeve of FIG. 5.

FIG. 6 is an exploded perspective view of the embodiment of the outer sleeve of FIG. 5 magnetically coupled through the magnetic clutch to the inner cementing string of FIG. 5A and enabled by rotation of the inner cementing string.

FIG. 6A is a elevation section view of FIG. 6 along the line 6A-6A, with the top portion of the outer sleeve and the casing string removed for simplicity.

### DETAILED DESCRIPTION

The following detailed description refers to the above-listed drawings wherein depicted elements are not necessarily shown to scale and wherein like or similar elements are designated by the same reference numeral through the several views.

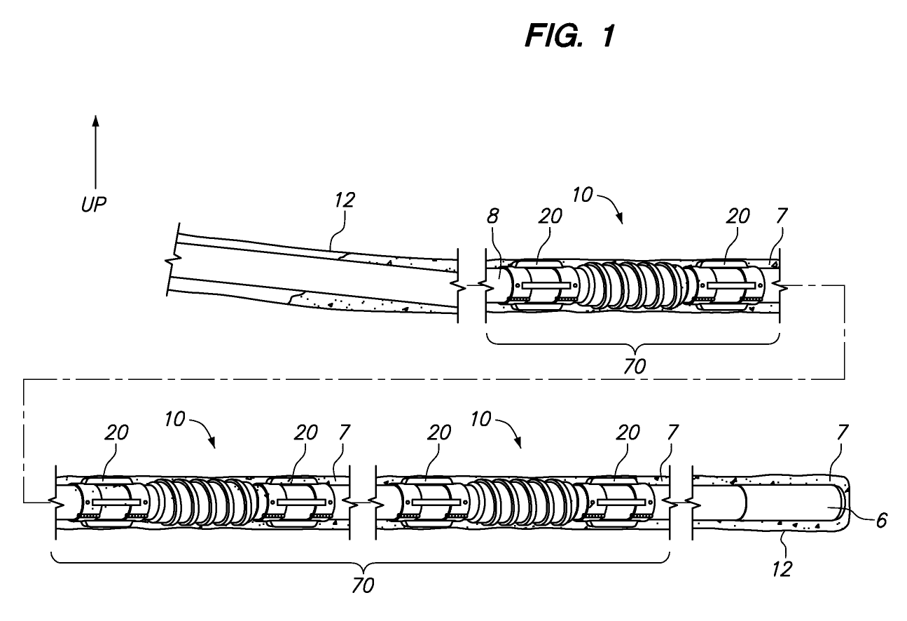

FIG. 1 is an elevation view of an extended reach borehole 12 having a substantial horizontal (relative to the surface) portion 70 and a casing string 8 disposed therein. A plurality of outer sleeves 10 are movably received on the casing string 8 in FIG. 1, an outer sleeve optionally straddled by a pair of centralizers 20. Depicted float device 6 is coupled to the end of the casing string 8 to prevent cement slurry displaced from the casing string into the annulus from flowing back into the borehole 12.

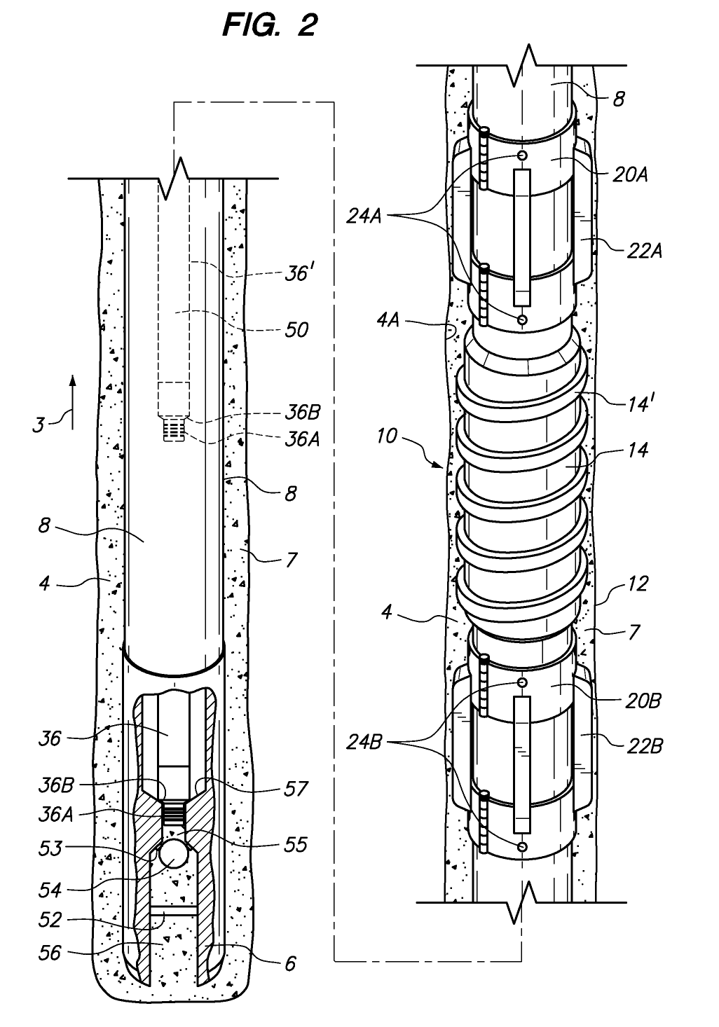

FIG. 2 is an enlarged elevation view of an embodiment of an outer sleeve 10 movably received on a casing string 8 and disposed within a borehole 12. The adjacent centralizers 20A, 20B straddle the outer sleeve 10 to position the casing string 8 and provide an annulus 4 around the casing string 8. It should be understood that the borehole in which the casing string 8 and the outer sleeve 10 are disposed may be vertical (as in FIG. 2), horizontal (FIG. 1) or any angle there between, and the drawings merely illustrate some of the orientations in which the invention may be used. The embodiment of the outer sleeve 10 illustrated in FIG. 2 comprises an exterior surface 14 with a spiral fin 14′ disposed thereon. The first centralizer 20A and a second centralizer 20B comprise rigid ribs 22A and 22B, respectively, extending radially from the casing string 8 to form the annulus 4 between the casing string 8 and the wall 4A of the borehole 12. The centralizers 20A, 20B may comprise set screws 24A, 24B to facilitate coupling the centralizers 20A, 20B adjacent to the outer sleeve 10 on the casing string 8. The centralizers 20A, 20B prevent or limit engagement of the exterior surface 14 or the fin 14′ with the wall 4A of the borehole 12. In other embodiments, the ribs of the centralizers may be pitched at an angle and formed to increase the level of turbulence of the annular flow.

Rotation of the outer sleeve 10 on the casing string 8 moves spiral fin 14′ through the cement slurry 7 within the annulus 4 and the exterior surface 14 of the outer sleeve 10 against the cement slurry in the annulus 4. Alternately, the outer sleeve 10 may comprise a plurality of generally parallel spiraling fins on the exterior surface 14. It should be understood that these and other embodiments may be useful, especially in a horizontal portion 70 of a borehole (see FIG. 1) to propel or assist in moving a cement slurry through the annulus 4 and reduce the equivalent circulating density (ECD) of the cement slurry.

FIG. 2 is also an enlarged elevation view of the float device 6 sealably engaged with a stinger 36A on the end of an inner cementing string 36′ and the portion of the casing string 8 adjacent to the float device 6. The float device 6 in FIG. 2 is illustrated with a window revealing the internal features of the float device 6 sealably receiving a stinger 36A on the end of the inner cementing string 36. It should be understood that the inner cementing string 36 may be run into the bore of the casing string 8 until the stinger 36A and stinger guide 36B seat within the receptacle 57 of the float device 6. FIG. 2 illustrates, in dotted outline, a position of the stinger 36A′ and inner cementing string 36′ prior to sealing engagement with the float device 6. This same position may be assumed upon disengagement of the inner cementing string 6 from the float device 6.

The float device 6 illustrated in FIG. 2 comprises an opening 55 intermediate the engaged stinger 36A and a ball chamber 56. The ball 54 is captured within the float device 6 between a ball seat 53 and a ball retainer 52, e.g., to function like a check valve. In FIG. 2, cement slurry 7 has been displaced from the bore 50 of the inner cementing string 36, through the stinger 36A, opening 55, ball chamber 56 and in the direction of arrow 3 through the annulus 4.

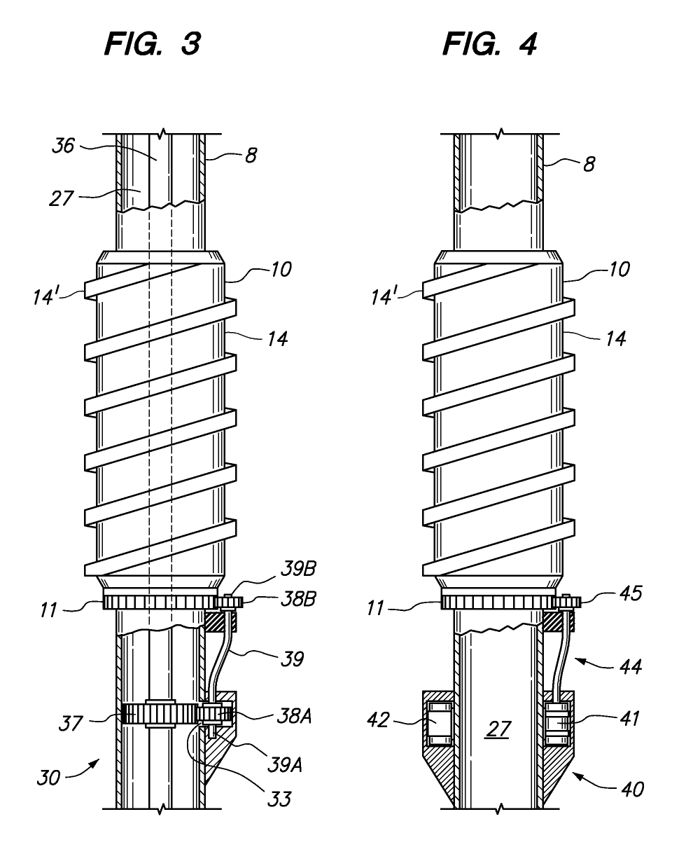

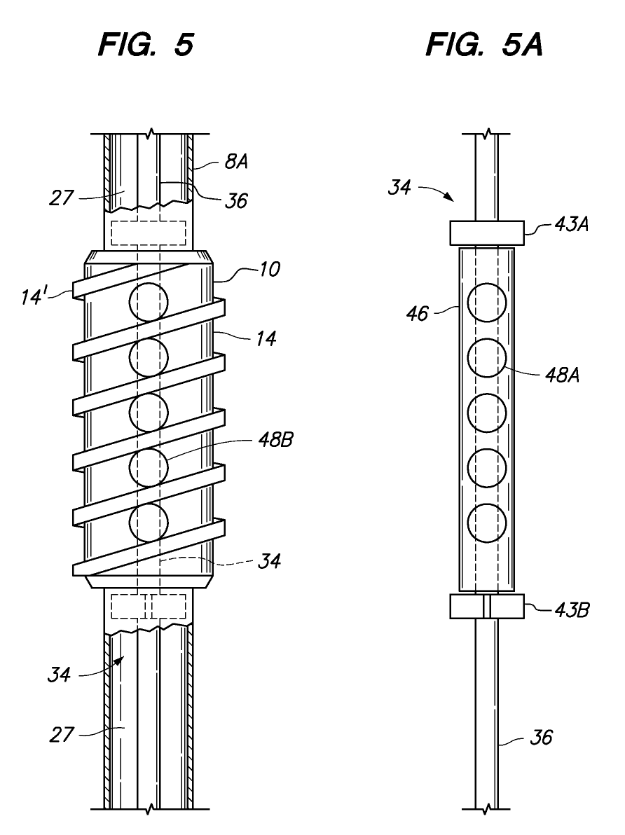

FIGS. 3 and 4 illustrate embodiments of an outer sleeve 10 rotatable on a casing string 8. FIG. 3 is an elevation view of an embodiment of an apparatus comprising an outer sleeve 10 movably coupled to a casing string 8 and a transfer device 30. A transfer device 30 operatively engages and rotates the outer sleeve 10 (not shown). The transfer device 30 illustrated in FIG. 3 comprises a drive gear 37 coupled to an inner cementing string 36 rotatably disposed within a bore 27 of the casing string 8. The drive gear 37 is positioned to engage an intermediate gear 38A protruding through a sealed aperture 33 in the casing string 8. The intermediate gear 38A engages and rotates a first end 39A of a flexible shaft 39 and an output gear 38B on the second end 39B of the flexible shaft 39 engaging the sleeve gear 11 on the outer sleeve 10. Rotation of the inner cementing string 36 rotates the drive gear 37 that engages and rotates the intermediate gear 38A, the flexible shaft 39, the output gear 38B and the sleeve gear 11 to rotate the outer sleeve 10.

FIG. 4 is an elevation view of another alternate embodiment of an apparatus having an outer sleeve 10 movably received on a casing string 8 and driven to rotate using a battery and a motor. The apparatus of FIG. 4 comprises an outer sleeve 10 rotatably received onto a casing string 8, the outer sleeve 10 comprising a sleeve gear 11 proximal a transfer device 40. The transfer device 40 comprises a battery 42 electrically coupled to an electrically-driven motor 41. The motor 41 is rotates a first end 44A of a flexible shaft 44 and an output gear 48 at the second end 44B of the flexible shaft 44. The output gear 45 drives the outer sleeve gear 11 to rotate the outer sleeve 10.

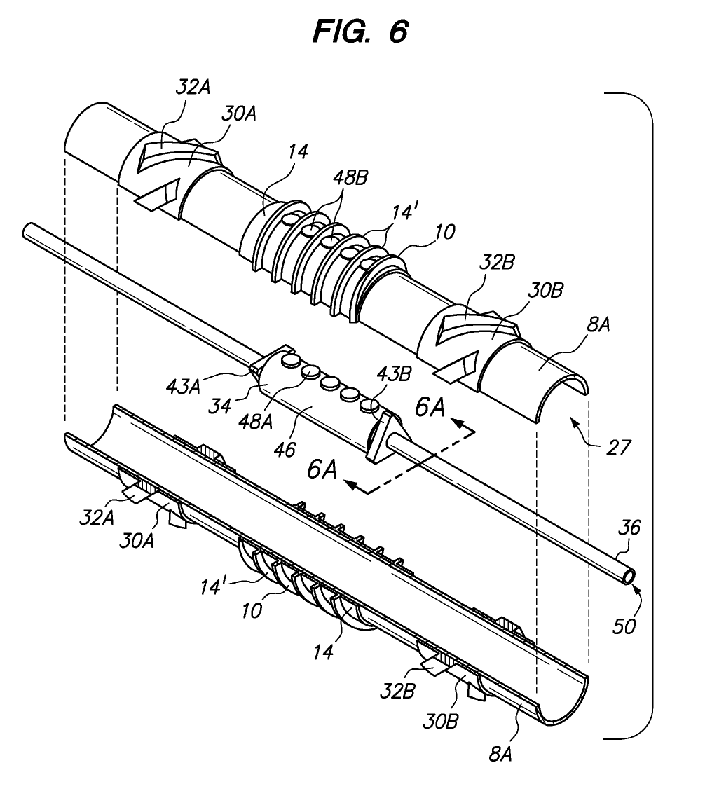

FIG. 5 is an elevation view of an embodiment of an apparatus having an outer sleeve 10 movably received on a non-magnetic casing segment 8A and rotatable on the casing segment 8A by a transfer device 34. The transfer device 34 illustrated in FIGS. 5 and 5A comprises an inner cementing string 36 coupled to an inner string 36 through a magnetic clutch. The magnetic clutch magnetically couples the inner cementing string 36 comprising inner magnets 48A to the outer sleeve 10 comprising outer magnets 48B. The outer magnets 48B are arranged on the outer sleeve 10 in a columnar pattern to cooperate with a transfer device 34 shown in FIG. 5A and superimposed on FIG. 5 to illustrate the interior position of the transfer device 34 after it is run and positioned within the bores of the non-magnetic casing segment 8A and outer sleeve 10. The outer sleeve 10 comprises an exterior surface 14 comprising a spiral fin 14′. It should be understood that a variety of arrangements of the outer magnets 48B may be used, and the arrangement illustrated in FIG. 5 is but an example of how the outer magnets 48B might be arranged on the outer sleeve 10.

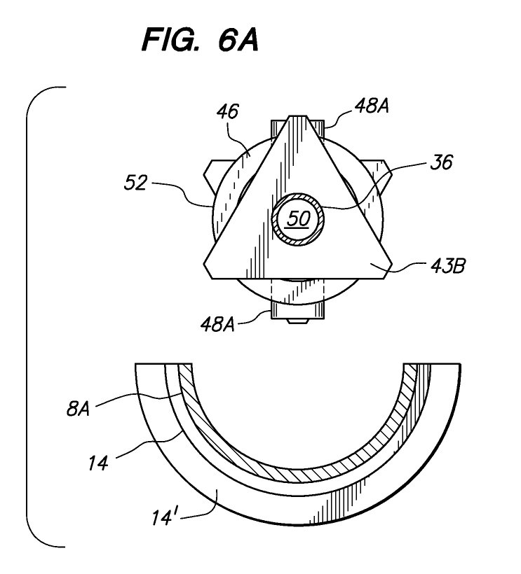

FIG. 5A is an elevation view of the embodiment of a transfer device 34 comprising an inner cementing string 36 to which inner magnets 48A are coupled in an arrangement coinciding with the arrangement of the outer magnets 48B on the outer sleeve 10 of FIG. 5. The inner cementing string 36 comprises a bore (not shown in FIG. 5A - see FIG. 6) through which cement slurry may be provided to the float device 6 (not shown in FIG. 5A—see FIG. 2). The pressure at which the cement slurry is delivered through the inner cementing string must be sufficient to displace cement slurry uphole through a substantial portion of the annulus toward the surface end of the borehole. It should be noted that “uphole” and “downhole” are in relation to the surface end of the borehole and do not necessarily define the inclination of the borehole.

The transfer device 34 shown in FIG. 5A further comprises a first spacer 43A and a second spacer 43B straddling the inner magnets 48A to radially position the inner magnets 48A within the bore of the non-magnetic casing segment 8A. It should be understood that the first and/or second spacers 43A, 43B may comprise a variety of shapes without loss of function. It should be understood that, when the inner casing string 36 is run into the bore 27 of the casing string 8 to position the transfer device 34 of FIG. 5A within the outer sleeve 10 as shown by the dotted lines in FIG. 5, spacers 43A, 43B on transfer device 34 shown of FIG. 5A engage the bore 27 of non-magnetic casing segment 8A to position the inner magnets 48A in general alignment with the outer magnets 48B as shown by the dotted lines in FIG. 5.

FIG. 6 is an exploded perspective view of the embodiment of the outer sleeve 10 of FIG. 5 magnetically coupled, through the magnetic clutch, to the inner cementing string 36 of FIG. 5A. Rotation of the outer sleeve 10 within the bore 27 of the casing segment 8A is obtained by rotating the inner cementing string 36 to magnetically transfer torque using inner magnets 48A interacting with outer magnets 48B. In the embodiments shown in FIGS. 5A and 6, the inner magnets 48A are disposed on an enlarged portion 46 of the inner cementing string 36 to more favorably position the inner magnets 48A to interact with the outer magnets 48B. It should be noted that, in FIG. 6, the outer sleeve 10 is movably received onto casing segment 8A and straddled by a first and second centralizers 30A, 30B having pitched ribs 32A, 32B thereon to facilitate agitation of a cement slurry flowing across the outer sleeve 10 as illustrated in detail in connection with the embodiment of FIG. 2.

FIG. 6A is an elevation section view of FIG. 6 along the line 6A-6A, with the top portion of the outer sleeve and the casing string removed for simplicity.

It should be understood that embodiments of the system, apparatus and the method may be used in an open borehole, as illustrated in FIGS. 1 and 2, or in a cased hole. The inner magnets and/or outer magnets used in embodiments of the invention may or may not comprise rare earth magnets. It should be understood that the non-magnetic casing segment 8A is provided to allow unimpaired the magnetic interaction between the inner magnets 48A and the outer magnets 48B, and that the non-magnetic casing segment 8A, which may be, for example, stainless steel, is made up into a casing string and run into a borehole to position the outer sleeve 10 at the targeted interval of the borehole. It should be understood that embodiments of the invention using multiple outer sleeves driven using a magnetic coupling between the inner cementing string and the outer sleeve may continue to effectively function notwithstanding disablement of one or more outer sleeves. For example, should an outer sleeve engage the borehole, for example, at a borehole irregularity or deviation, the inner string is not disabled from continued rotation within the bore of the casing string, and other outer sleeves may continue to rotate in response to rotation of the inner cementing string without damage to or substantial impairment of the intended benefit provided by the invention.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

From the foregoing detailed description of specific embodiments of the invention, it should be apparent that a system for enhancing the quality of cementing operations that is novel has been disclosed. Although specific embodiments of the system are disclosed herein, this is done solely for the purpose of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

I claim:

1. An apparatus to agitate an annular flow of cement slurry within a borehole, comprising:
an outer sleeve movably received on a casing string and having an exterior surface; and
a transfer device to move the outer sleeve relative to the casing string.

2. The apparatus of claim 1 wherein the transfer device rotates the outer sleeve relative to the casing string.

3. The apparatus of claim 1 wherein the transfer device reciprocates the outer sleeve along a portion of the casing string.

4. The apparatus of claim 1 wherein the exterior surface of the outer sleeve comprises one or more structures to increase an area of the exterior surface of the outer sleeve.

5. The apparatus of claim 4 wherein the one or more structures are selected from the group consisting of a fin, a blade, a dimple, a cavity, a groove, a bump, an undulation.

6. The apparatus of claim 1 wherein the transfer device comprises an inner cementing string receivable within a bore of the casing string, the inner cementing string comprising an inner magnet;
wherein at least one of the outer sleeve comprises at least one outer magnet to magnetically interact with the inner magnet to move the outer sleeve in response to a movement of the inner cementing string within the bore of the casing string.

7. The apparatus of claim 6 wherein the inner cementing string comprises a stinger sealably receivable within a float device receptacle coupled to the casing string.

8. The apparatus of claim 7 wherein the inner cementing string comprises a bore to provide a flow of cement slurry through the float device receptacle to an annulus formed intermediate the outer sleeve and the borehole.

9. The apparatus of claim 8 wherein a portion of the casing string on which the outer sleeve is movably received comprises a non-magnetic material.

10. The apparatus of claim 9 wherein the non-magnetic material is stainless steel.

11. The apparatus of claim 6 wherein at least one of the inner magnet and the outer magnet comprise a rare earth magnet.

12. The apparatus of claim 7 wherein the stinger comprises at least one seal to engage the float device receptacle.

14. The apparatus of claim 6 wherein the inner cementing string comprises a plurality of inner magnets in a first arrangement and the outer sleeve comprises a plurality of outer magnets in a second arrangement generally coinciding with the first arrangement to enhance the magnetic interaction between the inner cementing string and the outer element.

15. The apparatus of claim 14 wherein the first arrangement is generally columnar.

16. The apparatus of claim 2 wherein the transfer device comprises an electric motor.

17. The apparatus of claim 2 wherein the transfer device comprises an inner cementing string having a drive gear thereon to mechanically couple to the outer sleeve through a sealed aperture in the casing string.

18. A method of agitating an annular flow of a cement slurry comprising the steps of:
movably receiving an outer sleeve on a casing segment;
making up the casing segment into a casing string having a bore;
running the casing string into a borehole to form an annulus intermediate the outer sleeve and the borehole;
displacing a cement slurry through the annulus; and
moving the outer sleeve on the casing segment.

19. The method of claim 18, further comprising the steps of:
coupling at least one outer magnet to the outer sleeve;
coupling at least one inner magnet to an inner cementing string;
running the inner cementing string into the bore of the casing string;
sealably engaging the inner cementing string with a float device receptacle to position the inner magnet proximal the outer magnet; and
moving the inner cementing string to magnetically move the outer sleeve on the casing segment.

20. The method of claim 19, further comprising the steps of:
coupling a float device having a receptacle on the casing string;
receiving a first end of the inner cementing string into the float device receptacle; and
displacing the cement slurry through a bore of the inner cementing string and across an exterior surface of the outer sleeve.

21. The method of claim 18 further comprising the steps of:
coupling a centralizer to the casing string adjacent the outer sleeve to provide the necessary stand-off between the casing string and the borehole.

22. The method of claims 21 wherein the coupling at least one centralizer step comprises coupling a first centralizer and a second centralizer to the casing string to position the outer sleeve between the first and second centralizers.

23. The apparatus of claim 16 further comprising a battery coupled to drive the electric motor.

24. An apparatus to agitate an annular flow of cement slurry within a borehole, comprising:
an outer sleeve movably received on a casing segment and having an exterior surface; and
a transfer device to move the outer sleeve relative to the casing segment.

25. The apparatus of claim 24 wherein the transfer device rotates the outer sleeve relative to the casing segment.

26. The apparatus of claim 24 wherein the exterior surface of the outer sleeve comprises one or more structures to increase an area of the exterior surface of the outer sleeve.

27. The apparatus of claim 24 wherein the transfer device comprises an inner cementing string receivable within a bore of the casing segment, the inner cementing string comprising an inner magnet;
wherein the outer sleeve comprises at least one outer magnet to magnetically interact with the inner magnet to move the outer sleeve in response to a movement of the inner cementing string within the bore of the casing segment.

28. The method of claim 18 further comprising the steps of:
coupling a motor to the outer sleeve; and
operating the electric motor to move the outer sleeve on the casing segment.

29. The method of claim 28 wherein the step of coupling includes the steps of:
coupling a drive gear to the motor:
coupling a sleeve gear to the outer sleeve; and
mechanically coupling the drive gear to the sleeve gear through a sealed aperture in the casing segment.

30. The method of claim 28 further comprising the step of:
coupling a battery to the motor.
